(19) United States
(12) Patent Application Publication
(10) Pub. No.: US 2016/0330376 A1
(43) Pub. Date: Nov. 10, 2016

(54) APPARATUS AND METHOD FOR SPHERICAL LIGHT FIELD CAPTURE

(71) Applicant: OTOY, INC., Los Angeles, CA (US)

(72) Inventor: Paul Debevec, Los Angeles, CA (US)

(21) Appl. No.: 15/147,183

(22) Filed: May 5, 2016

Related U.S. Application Data
(60) Provisional application No. 62/157,816, filed on May 6, 2015.

(51) Int. Cl. H04N 5/232; H04N 5/225

(52) U.S. Cl. CPC H04N 5/23287; H04N 5/2251

(57) ABSTRACT

An imaging apparatus comprises a gantry with a pan and tilt rotating mechanism to which an elongated member is attached. The elongated member enables placing an image capture device at a forward offset from the center of rotation of the pan and tilt rotating mechanism. A real-world scenery is captured via rotation of the pan and tilt rotating mechanism which inscribes a sphere and positions the imaging device at the nodal points of the sphere for capturing images.

### CROSS REFERENCES TO RELATED APPLICATIONS

This application is a non-provisional of and claims priority to U.S. provisional patent application No. 62/157,816 filed on May 6, 2015 and entitled “APPARATUS AND METHOD FOR SPHERICAL LIGHT FIELD CAPTURE”, the entirety of which is incorporated herein by reference.

### FIELD

The present disclosure generally relates to image capture, and, more particularly, to capturing a spherical light field for obtaining real world images for virtual reality (VR) applications.

### BACKGROUND

Panoramic photography is often performed using a camera (such as a DSLR camera) placed upon an automated nodal rotation mount. Such mounts, offered by Gigapan, AutoMate, PanoGear, Rodeon, and TimeRanger, can typically be attached to a tripod and allow the camera to be mounted so that the nodal point of the camera lens is at or near the axis of rotation of both the horizontal (pan) and vertical (tilt) rotation axes. These mounts can be programmed to successively aim the camera in different directions and trigger the camera to take a picture when pointed in each direction. For example, the camera may be programmed to take a photo every 15 degrees of horizontal rotation and every 10 degrees of vertical rotation, resulting in (360/15)*(180/10)=432 photographs aimed in a regular sampling of pan and tilt angles looking out from the nodal point of the camera. If a lens with a 24 degree horizontal field of view and a 16 degree vertical field of view were used, then each photograph would have a region of overlap with the photographs taken above, below, and to the left and right of it. Such a set of photographs can be loaded into commercial (e.g. RealViz Stitcher) or open source (e.g. Panorama Tools) image stitching software, which can stitch the varying viewpoints into a single very high resolution panoramic digital image. With a 20 Megapixel camera, a panorama with over one billion sharp pixels could be created using this configuration. Some motorized pan/tilt rigs can also be programmed to have one or both motors move continuously at specified numbers of degrees per second, allowing a camera to be set to record video and to capture additional viewing directions even more quickly, at the expense of some motion blur or having to take shorter exposures.

### SUMMARY

This disclosure is related to an apparatus and method for capturing a spherical light field. An apparatus for capturing image as dataset for virtual reality (VR) applications is disclosed in some embodiments. The apparatus comprises a stabilizing base and a pan and tilt rotating mechanism attached to the stabilizing base and having a connection point proximate a center of rotation. An elongated member comprising a longitudinal axis is attached at a proximal portion to the pan and tilt rotating mechanism at the connection point. The elongated member comprises a first distal portion and a first mounting portion proximate the first distal portion for receiving an image capture device The first mounting portion has a distance from the connection point so as to offset the image capture device along the longitudinal axis such that as the mechanism pans and tilts the image capture device traverses a path generally corresponding to points on a surface of an imaginary sphere having a radius originating at the center of rotation and equal to said distance. In some embodiments, the distance between the first image capture device from the connection point is 50 centimeters.

In some embodiments, the elongated member further comprising a second distal end configured to receive a counter balance. In some embodiments, the first mounting mechanism is slidably securable along the elongated member for positioning at points along the longitudinal axis. In some embodiments, the elongated member is configured such that when attached, centers of gravity of the image capture device and the counter balance lie along the longitudinal axis of the elongated member. In some embodiments, the elongated member comprises a second mounting mechanism at the second distal portion, which second mounting mechanism is configured to receive a counter balance weight.

In some embodiments, the elongated member comprises only one distal end.

A method for generating image content is disclosed in some embodiments. The method comprises attaching a first image capture device having a fish eye lens and nodal point to a first distal end of an elongated member attached to a pan and tilt rotating mechanism. The pan and tilt rotating mechanism comprises a point of rotation and a connection point proximate said rotation point. The elongated member is connected at the connection point to the pan and tilt rotating mechanism so that the first distal end and the connection point are in spaced relation so as to define a distance between said nodal point and said point of rotation. The method further comprises causing, by a processor, rotation of the pan and tilt mechanism so that the nodal point traverses a path generally corresponding to a plurality of desired points on a surface of an imaginary sphere having a radius originating at the center of rotation and equal to said distance. The method also comprises causing, by the processor, rotation of the elongated member during the rotation of the pan and tilt mechanism so that the elongated member completes a single rotation comprising the plurality of desired points for each rotating position of the pan and tilt mechanism. Images of the real world space surrounding the image capture device are captured by the first image capture device at each of the desired points.

In some embodiments, the method comprises attaching a second image capture device to a second distal end of the elongated member. Images of the real world space are also captured by the second image capture device at each of the desired points diametrically opposite the first image capture.

A method of obtaining real world images for VR application is disclosed in some embodiments. The method comprises, attaching an image capture device comprising a fisheye lens to a pan and tilt mechanism having a point of rotation and a connection point proximate said rotation point. Said image capture device is connected said connection point so that a nodal point of the image capture device and the connection point are in spaced relation so as to define a distance between said nodal point and said point of rotation. The method further comprises programming the pan and tilt rotating mechanism to traverse a path generally corresponding to a plurality of desired points on a surface of an imaginary sphere having a radius originating at the said point of rotation and terminating at said nodal point. The method further comprises programming the image capture device to capture an image of a real world space at each of the plurality of desired points.

These and other embodiments will be apparent to those of ordinary skill in the art with reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is an illustration of the apparatus for recording the light fields in accordance with some embodiments;

FIG. 2 is an illustration showing the light field capture apparatus in accordance with some embodiments;

FIG. 3 is a schematic diagram showing the field of image capture of the image capture device when mounted on the elongated member of the gantry in accordance with embodiments described herein;

FIG. 4 is a portion of a dataset of images captured in accordance with some embodiments;

FIG. 5 is an example of a processed image that can be viewed in the lightfield viewing software;

FIG. 6 is an illustration wherein an interactive light field viewer software is employed to render stereo images of a scene in accordance with some embodiments;

FIG. 7 is a flowchart that details a method of capturing images of a real-world scenery in accordance with some embodiments;

FIG. 8 is a flowchart that details a method of programming the pan and tilt rotating mechanism to execute an imaging process in accordance with some embodiments; and

FIG. 9 is a schematic diagram of the internal architecture of a computing device in accordance with embodiments described herein.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Embodiments are described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Today's most compelling virtual reality (VR) experiences use a head-tracking system so that the user's viewpoint within the virtual environments shifts its position in concert with the user's head motion, giving a compelling sense of motion parallax. For computer generated scenes, such content is easy to author since the game engine can generate views from anywhere in the scene on demand. Photographic VR content, by contrast, generally does not provide motion parallax in response to head motion since it is filmed from fixed camera locations and the images sent to the VR headset. Experiencing photographic VR content, however, usually does not offer the effect of motion parallax since at any given time, the images have been acquired from fixed viewpoints. This is case for 360 degree panoramas, and even 360 stereo panoramas, which offer left eye/right eye panoramic views from different locations but fail to allow the viewpoint to move away from the original viewpoints.

One technique for changing the viewpoint of a photographed scene in response to a user's head movement is image-based rendering, where the images are projected onto a 3D geometric model of the scene as texture maps and re-projected into a novel viewpoint. The geometric model of the scene can be obtained from manual 3D modeling, photogrammetry, or determining depth from stereo correspondence. Projecting imagery from one point of view into another, however, does not properly reproduce view-dependent changes in appearance as could be seen in the reflections of a shiny tabletop or translucency seen through a stained glass window. As a result, the world is visualized in such a way can appear relatively dull and flat.

Light Field Capture and Rendering records an image-based dataset of a scene using computer graphics renderings or real photographs from a 2D array of different points of view, and synthesizes new points of view out of the pixels of the images in an array. In this formulation, the points of view are arrayed in a plane, and can be recorded using a planar motion gantry. Notably, since radiance remains constant along a ray, the views which can be synthesized are not restricted to be within the plane of the original viewpoints, and can be generated both in front of and behind the original capture plane. If viewed in a head-mounted display, such a dataset would allow for the effect of motion parallax as the user moves their head, and view-dependent reflection effects will be reproduced up to the resolution of the light field. Sampling artifacts due to a limited number of views in the light field can be remedied by projecting the light field information onto approximate 3D geometry of the scene. Also, optical flow between the views of the light field can be used to interpolate between the views to virtually increase the apparent resolution of the sampling.

A standard way to capture a photographic light field is to use a planar light field gantry, where the camera is translated horizontally and vertically to cover a grid lattice of viewpoints. The camera is mounted to point perpendicular to the light field capture plane, and a photo is taken at each location, such as a grid of 64×64 image. This is inadequate, however, because in a virtual reality headset, the user is free to look in any direction, and it is very desirable for the scene to be photographed in all possible directions including looking up, down, left, right, forward, and back. For example, if there were light field data captured for rendering of the static space, a person viewing a room with a glass tabletop and moving relative to the glass tabletop would see the reflections of light in the glass tabletop change relative to the virtual reality viewer's virtual position change in the space.

As mentioned earlier, panoramic photography is often performed using a camera placed upon an automated nodal rotation mount. Nonetheless, motorized pan/tilt heads which are used to construct two-dimensional panoramas, represent (or approximate) only a single viewpoint in space. Such pan/tilt heads cannot be used on their own to simulate the motion parallax one would experience moving one's head around within a scene in a VR device. Embodiments described herein pertain to a mechanical apparatus and methods of using same that enables recording light fields with a camera mounted to a motorized pan/tilt head which pan/tilt head comprises an extension support or an elongated member such as a mounting arm or other physical structure and the use of captured image data. The extension support enables placing the camera at a selected or selectable (e.g. fixed or variable) distance forward from where a camera would typically be placed relative to the horizontal and vertical rotation axes on the pan and tilt head without the extension.

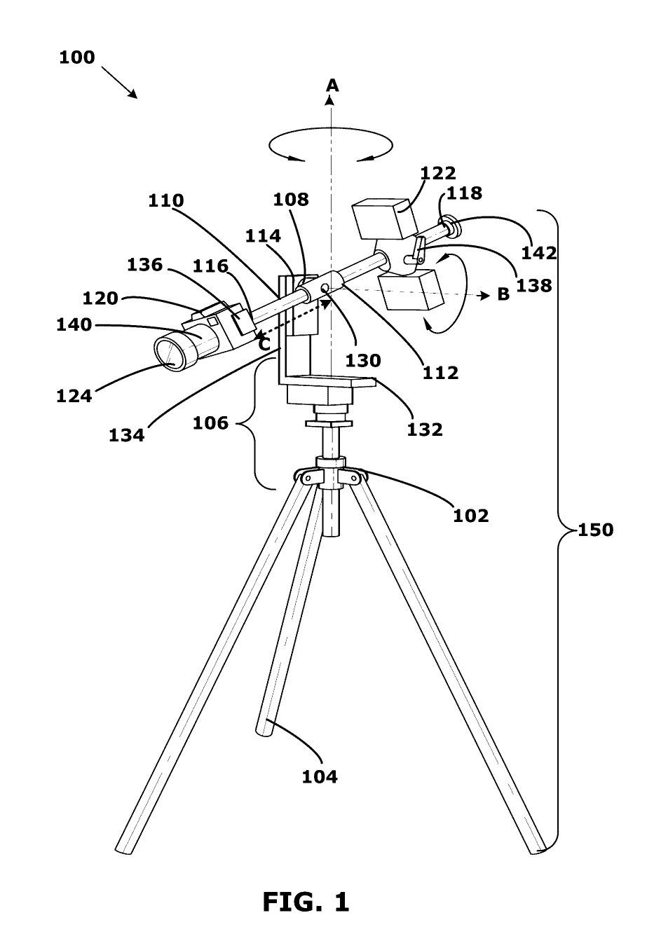

FIG. 1 is an illustration of the apparatus 100 for recording the light fields in accordance with some embodiments. The apparatus comprises an image capture device 120 mounted on a base or stand or frame structure or a gantry 150. The gantry 150 comprises a tripod or other stabilized or stabilizable base 102 having one or more legs 104 or a plinth upon which a pan/tilt rotating mechanism 106 can be mounted. In some embodiments, the rotating mechanism 106 can comprise a motorized pan and tilt mechanism which rotates along the vertical axis A and remotely controllable by a computing device. The rotating mechanism 106 comprises a horizontal segment 132 and a vertical segment 134, and can be (“shaped, “U” shaped or take on other shapes that can accommodate the spherical path of the device 120 as set forth herein. A rotating plate 114 is attached to the vertical slab 134. In some embodiments, the distance of the horizontal slab 132 around the axis A and the height of the rotating plate 114 from the horizontal slab 132 are configured to be adjusted. In some embodiments, manual rotating mechanisms can also be utilized. Such pan and tilt mechanisms are known in the art, and will likely be improved in the future as will be become known in the art, but in any event embodiments utilize mechanisms that permit rotation of a mounting surface through a 360 degree or near 360 degree range of motion.

Connected to the rotating mechanism 106 is a sleeve structure 108 or other mounting configuration attached to the rotating plate 114 for holding an elongated member 110 or a mounting arm such as a bar, a rod or other elongated member. In some embodiments, the distance of the sleeve structure 108 from the rotating plate 114 can be configured for adjustment so that a user can set the distance between the elongated member 110 and the rotating plate 114. The elongated member 110 is configured to place an image capture device 120 such as a camera a selected distance forward by a forward offset distance ‘C’ from where a camera would typically be placed relative to the horizontal and vertical axes A and B. In some embodiments, the forward offset distance ‘C’ can be the distance between the rotation point 130 and the nodal point 140 of the image capture device 120. Generally a nodal point or entrance pupil or no parallax point (NPP) of the image capture device 120 can be a point where the light refracts or reverses itself before continuing to the image sensor or film plane. The entrance pupil is different on each lens and changes at different focal lengths. In some embodiments, the forward offset distance ‘C’ can be about 50 centimeters or more. Thus, there is no imaging apparatus proximate the vertical axis A of the pan and tilt rotating mechanism 106. Rather, the image capture device 120 is located at one of the distal ends of the elongated member 110.

It can be appreciated that the sleeve 108 is only shown by the way of illustration and not limitation and that other holding structures can also be used in some embodiments. The elongated member 110 is configured for rotation along the horizontal axis B thereby describing a spherical rotation path around the mounting point 130. In some embodiments, the sleeve structure 108 can be configured to clamp the elongated member 110 at a desired angle relative to the rotating plate 114, while the rotating mechanism 106 rotates the elongated member 110 through the various positions.

The elongated member 110 has a proximal end 112 for connection to the mounting surface 114 of the rotating mechanism 106. In some embodiments, the elongated member 110 may have two distal ends 116, 118 wherein an image capture device 120 can be mounted at the first distal end 116 and a counter balance 122 can be mounted at the second distal end 118 which is opposite the first distal end 116 along the longitudinal axis of the elongated member 110. The counter balance 122 can have substantially equal weight as the image capture device 120. In some embodiments, the counter balance 122 can comprise removable weight pieces so that its weight can be increased or decreased as needed. This enables the elongated member 110 to balance cameras of different weights with such variable weight counter balance.

In some embodiments, one or both of the distal ends 116, 118 can be configured with receiving brackets 136 or screw mechanism or other known attaching mechanism that enable attaching the image capture device 120 and the counter balance 122 to the elongated member 110 in accordance with embodiments described herein. In some embodiments, the counter balance 122 can be configured to fit snugly yet slidable on the elongated member 110 and can be fixed at a desired position via a tightening screw 138. In some embodiments, the distal end 118 can be configured with a removable stopper 142 that enables replacing the counter balance 122. In some embodiments, the removable stopper 142 can be replaced with another receiving bracket such as the bracket 136 so that another camera can be attached to the distal end 118.

In some embodiments, the elongated member 110 can have only one distal end 116 and may not have the second distal end 118. In other words, if the counter balance 122 is sufficiently close to the mounting surface 114 of the pan and tilt mechanism 106, or if the pan and tilt mechanism 106 is geared to permit the motion of the elongated member 110 with the image capture device 120 mounted thereon without the need for a counter balance 122, then the elongated member 110 can terminate at or near the mounting point at the proximal end 112 where it is connected to the mounting surface 114. In embodiments where the elongated member 110 contains the two distal ends 116 and 118, the counter balance 122 can be another light field capturing camera or image capture device equipped with a fish eye lens having a weight similar to the light field capture device 120 at the first distal end 116 of the elongated member 110 such that the cameras can be operated simultaneously or near simultaneously and reduce the number of positions through which the rotating mechanism 106 including the elongated member 110 will need to be rotated to completely capture a view of the interior space being imaged.

When placed in such offset position, the image capture device 120 can record a spherical outward-looking light field of a scene, such as the interior of a kitchen, the throne room of an ancient castle, or the fifty-yard line of a football stadium. In some embodiments, moving the image capture device 120 through a sufficient number of positions, results in a series of images of the scene. The images can then be pieced together to form a body of data that represents the visual representation of the static interior of the space. By providing a viewer that permits a person in a virtual reality world to perceive the image data collected, the person, by moving their head or moving about in the virtual reality space, can perceive the change of view and/or the movement of the viewer within the physical space. If the image capture device 120 can also, a light field capturing device, although a quality camera with a fish eye lens produces images of satisfactory resolution. Camera and lens quality can vary as a matter of design choice, with higher quality generally yielding higher resolution.

In some embodiments, the lens 124 of the image capture device 120 can be a fish eye lens with the direction of the lens 124 pointing out from the center of rotation of the rotating mechanism 106. The utilization of a fish eye lens, rather than the use of a zoom or other non-fish eye lens, for capturing the image data permits a greater amount of light field data to be captured for each position change as the image capturing device 120 moves along the spherical path during light field data capture. The use of a fisheye lens 124 results in a significant amount of overlap of the data for each successive image data capture position that is traversed by the apparatus during image capture. This utilizes an intentional parallax effect that can be used to advantage when stitching the images containing the light field data together to form the light field data representing the physical space being imaged for use in a virtual reality or augmented reality environment. By capturing image data with a fisheye lens rotated in a spherical path to capture the static space image, a three hundred and sixty degree light field view of the static image to be utilized in the virtual reality environment can be obtained.

In some embodiments, the rotating mechanism 106 can be programmed to aim the image capture device 120 in various directions, such as a set of 72 images spaced five degrees apart rotating around the vertical axis A and 24 images spaced five degrees apart around the horizontal axis B, resulting in a set of 72 times 24 or 1728 images. If a fisheye lens or other wide-angle lens with a field of view of approximately 180 degrees or more is used, such a light field can provide the photographic data necessary to render views of the scene from any position within the sphere inscribed within the nodal points of the camera positions from which photographs are taken using the pan/tilt mount. In fact, the data is sufficient for rendering views even further away from the offset distance.

The embodiments of spherical light field capture apparatus and methods described herein differ from the traditional practice of panoramic photography using a motorized pan/tilt head. First, the image capture device 120 or the camera is intentionally offset forward from the center of rotation 130 of the pan/tilt head of the rotating mechanism 106. This results in misregistered imagery for stitching a 2D panorama from all of the images. Second, the field of view of the image capture device 120 is very wide relative to the spacing of the horizontal and vertical viewpoints, such that most of one image covers the same scene content as the ones adjacent to it in the grid of images, though from a slightly different viewpoint. (In traditional panoramic photography where the camera is mounted nodally on the rotating mechanism 106, this would not be done, as it would be wasteful of the field of view and image resolution of the camera, recording many parts of the scene very redundantly). Third, the images are not stitched into a single panorama, but rather are kept as a database of a two-dimensional array of two-dimensional images, forming a four-dimensional light field dataset.

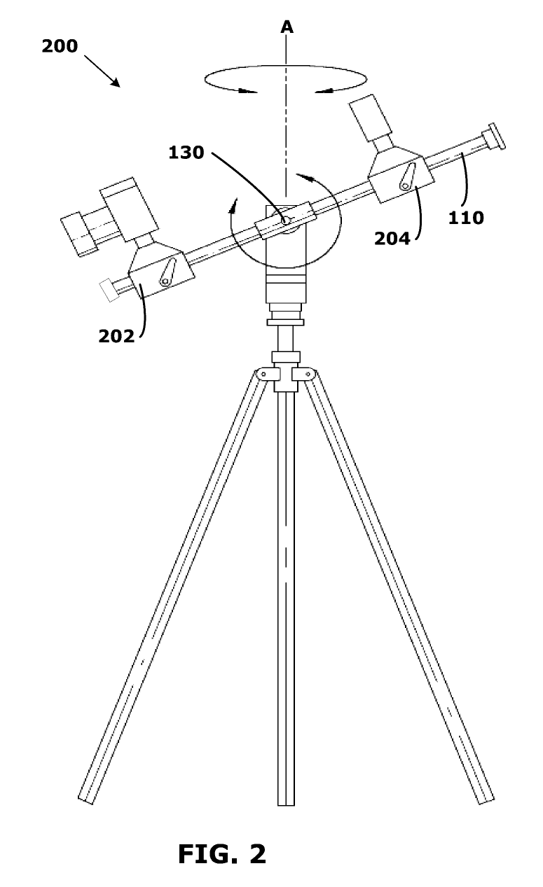

FIG. 2 is an illustration showing the light field capture apparatus 200 in accordance with some embodiments. The description of similar elements is omitted for brevity. In the apparatus 200, one or more of the image capture device 120 and the counter balance 122 are configured to be positioned along the elongated member 110. The elongated member 110 can be configured with two mounting mechanisms 202 and 204 which are preferably positionable at various locations along the length of the elongated member 110 so that their distances from the axis of rotation A or the mounting point 130 of the elongated member 110 to the rotating 106 mechanism can be adjusted as required to suit the needs of the specific scene being captured. Thus, one or more of the image capture device mounting mechanism 202 and the counter balance mounting mechanism 204 can be fixed or slideable along the elongated member at various distances from the access of rotation. In some embodiments (not shown) the length of elongated member 110 can be adjustable by using a telescoping technique or mechanism to change the overall length of member 110.

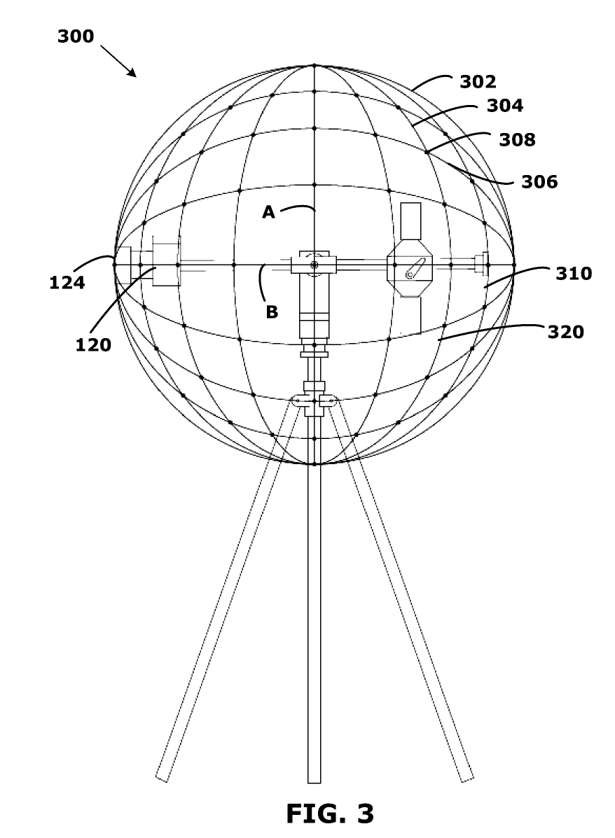

FIG. 3 is a schematic diagram 300 showing the field of image capture of the image capture device 120 when mounted on the elongated member 110 of the gantry 150 in accordance with embodiments described herein. As mentioned above, the rotating mechanism 106 can be programmed to aim the image capture device 120 in various directions and capture images at each position that is spaced apart from the next position by specific predetermined degrees. For example, a set of 72 images can be obtained from positions spaced five degrees apart rotating around the vertical axis A and 24 images spaced five degrees apart around the horizontal axis B, resulting in a set of 72 times 24 or 1728 images. Any member of images, at any number of positions, can be obtained, depending on the scene or space being imaged and he image data density sought. As the rotating mechanism 106 rotates around the vertical axis A and the elongated member 110 rotates along the horizontal axis B. For example, the elongated member 110 can complete a single rotation comprising a plurality of image capture positions 310, 320 etc., for each of the rotating position or circular trajectory 310, 320 etc., of the pan and tilt mechanism 106. Based on programmed positions, space traversed by the image capture device 120 generally describes an imaginary sphere 302 having a radius generally equal to the distance between the rotation point 130 and the focal or nodal point of the image capture device 120 with the desired image capture path of the image capture device 120 being indicated by the vertical lines, for example line 304 and the horizontal lines such as line 306. The points of intersection of the vertical and the horizontal lines or nodal points of the sphere 302, for example point 308 are the positions at which each of the 1728 images (or however many images are desired) are captured. Of course the traversal of the image capture device 120 can follow any of a number of paths along a surface of the imaginary sphere 302. If the lens 124 on the image capture device 120 is a fisheye lens with a field of view of approximately 180 degrees or more, such a captured light field can provide the photographic data necessary to render views of the scene from any position within the sphere 302.

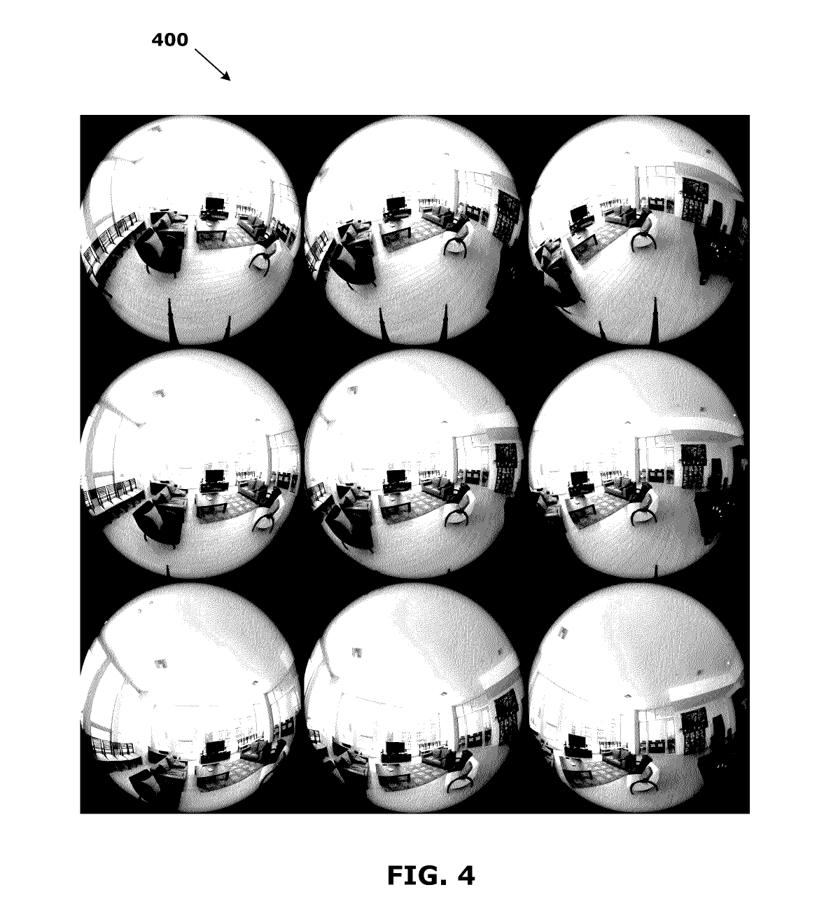

FIG. 4 is a portion of a dataset of images captured in accordance with some embodiments. In particular, a Contact Sheet grid 400 of nine of the 72×24=1728 fisheye images taken using the apparatus 100 is shown. They are sampled 30 degrees apart from one image to the next (left/right or up/down) which implies that the real sampling is actually six times denser at 5 degrees apart in both the vertical and horizontal dimensions. This is due to the overlap that each image or photograph has with the photographs taken above, below, and to the left and right of it.

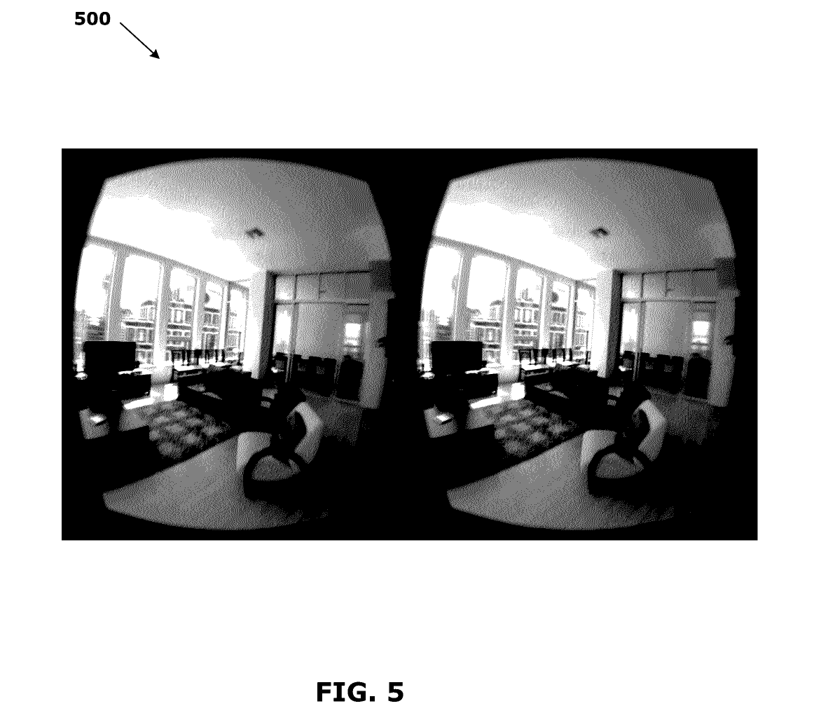

The spherical light field dataset captured using the light field capture apparatus 100 in accordance with embodiments described herein may be processed so that it can be viewed in interactive light field viewing software. FIG. 5 is an example of a processed image 500 that can be viewed in the lightfield viewing software. This processing can comprise resampling, undistorting, virtually rotating, mosaicking, compositing, or color correcting the images for use in the viewer. In addition, one or more image compression (such as JPEG) and/or light field compression (such as vector quantization) techniques can be employed to reduce the size of the data, leveraging the compressibility of the light field dataset along one or more of its four dimensions. In some embodiments, a light field viewer software can generate virtual views of the scene from within the vicinity of the viewpoints comprising the light field dataset. Generating these virtual views proceeds by determining, for each pixel of the virtual view, which linear combination of rays represented within the light field dataset best predict the radiance of the scene along that pixel's ray. In some embodiments, the quality of the rendered light field can be improved by correcting the ray intersection points using depth correction.

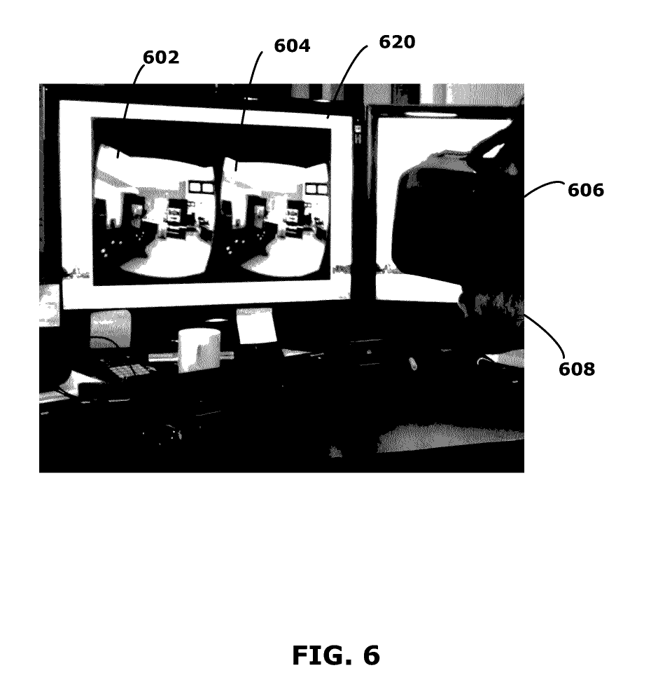

FIG. 6 is an illustration 600 wherein an interactive light field viewer software is employed to render stereo images 602, 604 of a scene. While a display of the stereo images 602, 604 is shown on the monitor 620, the stereo images 602, 604 are also shown on a display of a virtual reality (VR) headset 606 being employed by the user 608. Each of the stereo images 602, 604 are shown to the left and right eyes the user 608 by the head-mounted virtual reality (VR) headset 606. By the way of illustration and not limitation, the virtual reality headset can comprise headsets such as an Oculus Rift™ or an HTC Vive™ or a Sony Morpheus™. The viewpoint of the left and right eye views can be determined interactively by the head tracking system comprised in the virtual reality headset 606, so that the two eye viewpoints are matched to the motions of the user's head within the scene. If a light field is captured with a camera offset of 50 cm from the center 130 of the pan/tilt rotation, enough volume of renderable viewpoints can be generated to accommodate the motions of the head of a seated person. To accommodate VR users able to move about more freely, such as a person free to move about a room, a larger spherical light field dataset can be captured, or multiple spherical light fields can be captured, and the light field the user is closest to will be used at any given time.

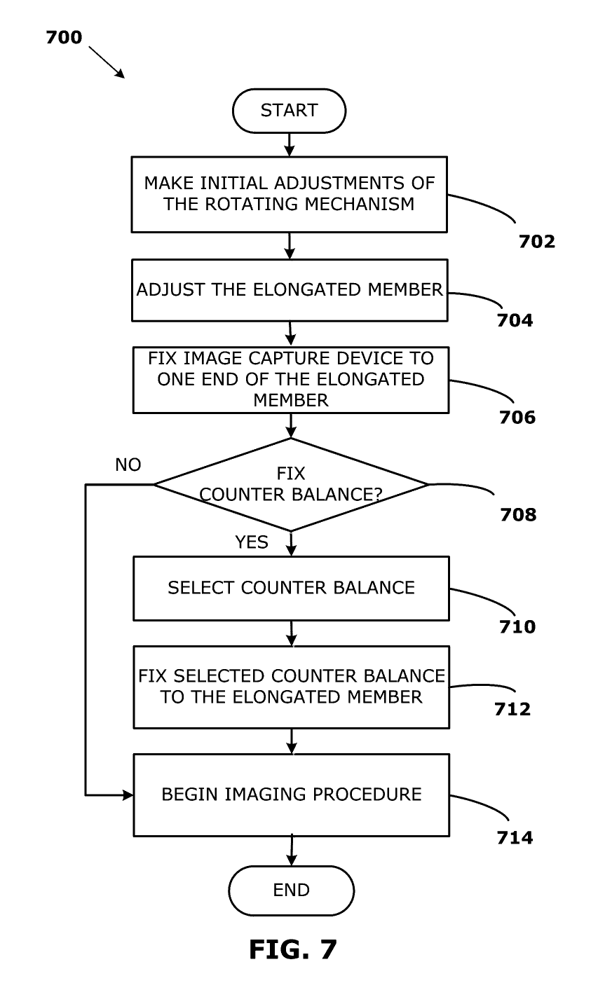

FIG. 7 is a flowchart 700 that details a method of capturing images of a real-world scenery in accordance with some embodiments. The method begins at 702 wherein the initial adjustments of the pan/tilt rotating mechanism 106 are made. The initial adjustments can comprise without limitation, the offset of the horizontal slab around the vertical axis A, the height of the rotating plate 114 from the horizontal slab 132 and the like. Furthermore, the initial settings can comprise attaching the elongated member 110 to the rotating plate 114, for example, via insertion of the elongated member 110 into the sleeve structure 108. At 704, the distribution of mass of the elongated member 110 about the center of rotation 130 can be adjusted. As discussed herein, the elongated member 110 can be adjusted to so that it comprises a proximal end 112 and two distal ends 114, 116. In some embodiments, the elongated member 110 can be adjusted so that only one distal end 114 is manifested wherein the elongated member 110 does not extend through the sleeve structure 108 to its other side. At 706, the image capture device 120 is fixed to one of the distal ends 114, 116 of the elongated member 110. Based on whether another distal end is manifested it is determined by a user at 708 if the counter balance 122 needs to be fixed to the other distal end. If it is determined at 708 no counter balance is required, the method proceeds to 714, wherein the imaging procedure is commenced via the activation of the pan/tile rotating mechanism 106 and the image capture device 120. If it is determined at 708 that a counter balance is required, then the type of counter balance to be fixed can be determined at 710. The counter balance 122 can be a simple weight that servers to balance the weight of the image capture device 120 on the elongated member 110 in some embodiments. In some embodiments, the counter balance 122 can be a second image capture device so that two images of two different portions of the real-world scenery can be simultaneously captured thereby speeding up the process of image capture. The determined counter balance is attached to the distal end 116 of the elongated member 110 which is opposite the distal end 114 to which image capture device 120 is attached. The method proceeds to 714, wherein the imaging procedure is commenced via the activation of the pan/tilt rotating mechanism 106 and the image capture device 120.

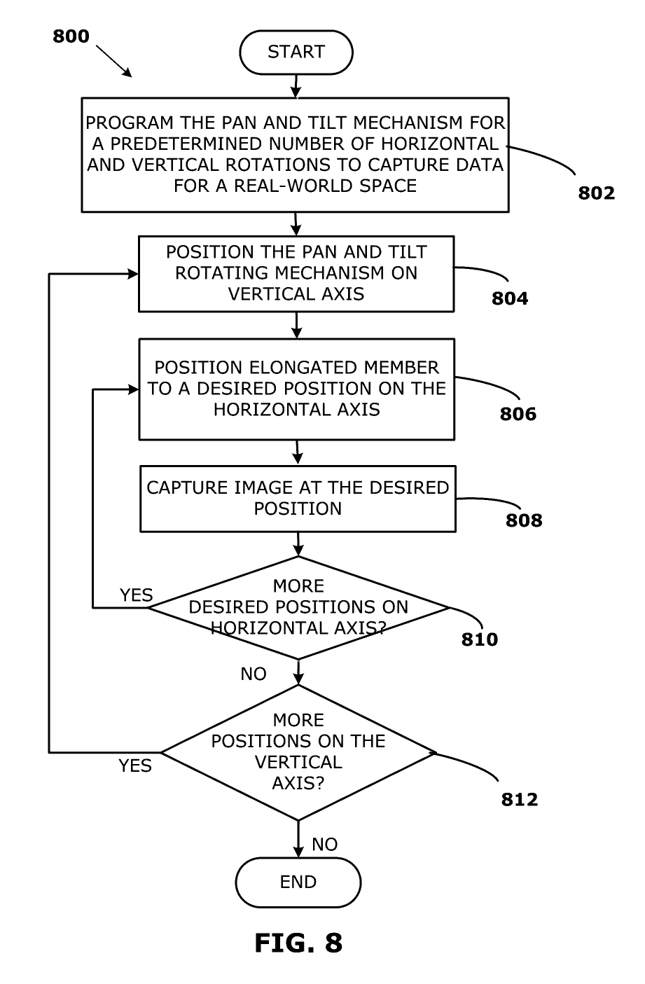

FIG. 8 is a flowchart 800 that details a method of programming the pan and tilt rotating mechanism to execute an imaging process in accordance with some embodiments. The method begins at 802 wherein the pan and tilt rotating mechanism 106 is programmed for a predetermined number of rotations on the vertical and horizontal axes to capture data of a physical space or real-world surroundings of the apparatus 100. In some embodiments, the number of rotations on the horizontal and vertical axes can be based on the number of images of a real world space that may be desired by a user. In the example discussed above, if a set of 1728 images are desired, the pan and tilt mechanism can be programmed to move through 72 different positions on the vertical axis A and further move the elongated member 110 through 24 different desired positions on the horizontal axis B for each of the 72 different vertical axis positions.

Accordingly at 804, the pan and tilt rotating mechanism is moved to a first position to begin the imaging process. In some embodiments, the first position can be the initial position at which the pan and tilt rotation mechanism 106 begins operating when activated. Upon being positioned at the initial position on the vertical axis A at 804, the pan and tilt rotating mechanism 106 is further activated to move to a first one of a plurality of desired positions along the horizontal axis B at 806. Consequently, the elongated member 110 is also moved to a first one of the number of desired positions along the horizontal axis B by the virtue of its attachment to the rotating mechanism 106. At 806 when the pan and tilt rotating mechanism 106 is positioned at a first desired position along the vertical axis A and the elongated member 110 is positioned at a first desired position on the horizontal axis B, the image capture device 120 is activated at 808 to capture an image of a real world space in which the apparatus 100 is located. At 810, it is determined if there are more positions on the horizontal axis B that need to be traversed. If yes, the method returns to 806 wherein the elongated member 110 is moved to the next position on the horizontal axis B and the image capture device 120 is activated to capture another image of the real world space. Thus, upon the elongated member 110 being moved to each of the plurality of desired positions and the images being captured at each of the plurality of desired positions on the horizontal axis B, it is determined at 810 that there are no more positions on the horizontal axis B that need to be traversed. The method moves to 812 wherein it is determined if there are more positions on the vertical axis A that the rotating mechanism 106 needs to traverse. If yes, the method returns to 804 wherein the rotating mechanism moves to the next position on the vertical axis A. Upon the rotating mechanism 106 thus completing the rotations along the vertical axis A for which it is programmed, it can be determined at 812 that there are no more positions on the vertical axis that need to be traversed and the method terminates on the end block.

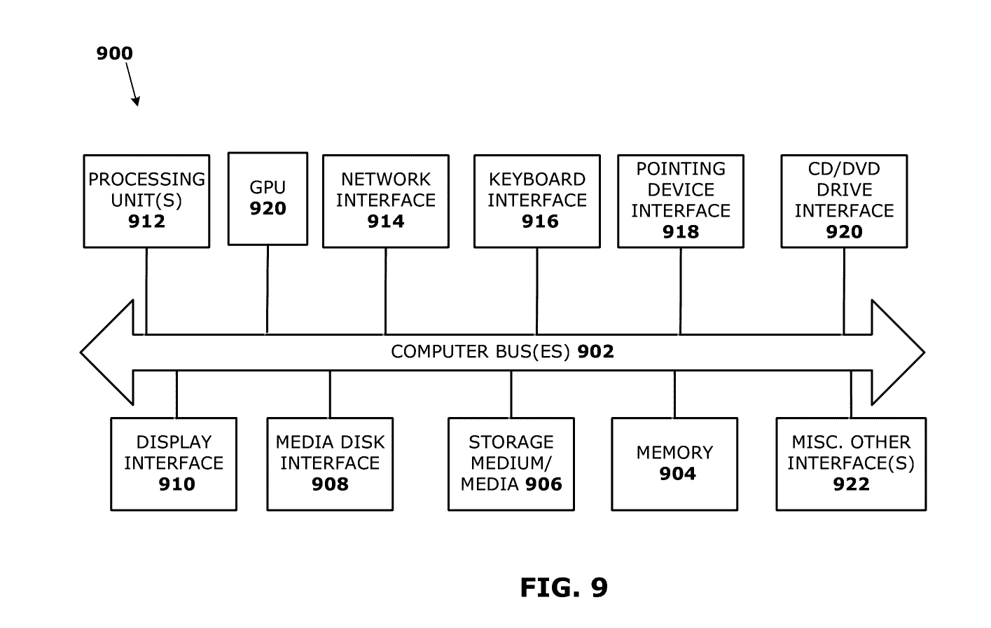

FIG. 9 is a schematic diagram of the internal architecture of a computing device 900 in accordance with embodiments described herein. The computing device 900 can be employed as a processing and/or rendering device that processes the light field data sets captured by the apparatus 100 and renders the stereo images that are presented to users via VR headsets in accordance with some embodiments. In addition, the computing device 900 can also comprise programming modules for controlling the apparatus 100 during the image capture process.

In an embodiment, the computing device 900 includes one or more processing units (also referred to herein as CPUs) 912, which interface with at least one computer bus 902. In some embodiments, computing device 900 can comprise a GPU (Graphics Processing Unit) which comprises one or more integrated circuits and/or processing cores that are directed to mathematical operations commonly used in graphics rendering. In some implementations, the GPU 920 may use a special graphics unit instruction set, while in other implementations, the GPU may use a CPU-like (e.g. a modified x86) instruction set. Graphics processing unit 920 can implement a number of graphics primitive operations, such as blitting, texture mapping, pixel shading, frame buffering, and the like. Graphics processing unit 920 may be a graphics accelerator, a GPGPU (General Purpose GPU), or any other suitable processing unit.

Also interfacing with computer bus 902 are persistent storage medium/media 906, network interface 914, memory 904, e.g., random access memory (RAM), run-time transient memory, read only memory (ROM), etc., media disk drive interface 908, an interface 920 for a drive that can read and/or write to media including removable media such as floppy, CD-ROM, DVD, etc., media, display interface 910 as interface for a monitor or other display device, keyboard interface 916 as interface for a keyboard, pointing device interface 918 as an interface for a mouse or other pointing device, and miscellaneous other interfaces 922 not shown individually, such as parallel and serial port interfaces, a universal serial bus (USB) interface, and the like.

Memory 904 interfaces with computer bus 902 so as to provide information stored in memory 904 to CPU 912 during execution of software programs such as an operating system, application programs, device drivers, and software modules that comprise program code or logic, and/or computer-executable process steps, incorporating functionality described herein, e.g., one or more of process flows described herein. CPU 912 first loads computer-executable process steps or logic from storage, e.g., memory 904, storage medium/media 906, removable media drive, and/or other storage device. CPU 912 can then execute the stored process steps in order to execute the loaded computer-executable process steps. Stored data, e.g., data stored by a storage device, can be accessed by CPU 912 during the execution of computer-executable process steps. In some embodiments, the stored data can comprise content objects. A content data object or a content object, in particular implementations, is an individual item of digital information typically stored or embodied in a data file, binary large object (BLOB) or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof.

Persistent storage medium/media 806 is a computer readable storage medium(s) that can be used to store software and data, e.g., an operating system and one or more application programs. Persistent storage medium/media 806 can also be used to store device drivers, such as one or more of a digital camera driver, monitor driver, printer driver, scanner driver, or other device drivers, web pages, content files, metadata, playlists and other files. Persistent storage medium/media 806 can further include program modules/program logic in accordance with embodiments described herein and data files used to implement one or more embodiments of the present disclosure.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), program logic, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1) An apparatus comprising:
a stabilizing base;
a pan and tilt rotating mechanism attached to the stabilizing base and having a connection point proximate a center of rotation; and
an elongated member comprising a longitudinal axis, a proximal portion attached to the pan and tilt rotating mechanism at the connection point, a first distal portion, and a first mounting mechanism proximate the first distal portion for receiving an image capture device, the first mounting mechanism having a distance from the connection point so as to offset the image capture device along the longitudinal axis such that as the mechanism pans and tilts the image capture device traverses a path generally corresponding to points on a surface of an imaginary sphere having a radius originating at the center of rotation and equal to said distance.

2) The apparatus of claim 1, the elongated member further comprising a second distal end.

3) The apparatus of claim 1, wherein a second distal end of the elongated member is configured to receive a counter balance.

4) The apparatus of claim 3, further comprising the counter balance.

5) The apparatus of claim 3, the elongated member is configured such that when attached, centers of gravity of the image capture device and the counter balance lie along the longitudinal axis of the elongated member.

6) The apparatus of claim 1, wherein the first mounting mechanism is slidably securable along the elongated member for positioning at points along the longitudinal axis.

7) The apparatus of claim 6, wherein a second mounting mechanism is configured to receive a counter balance weight.

8) The apparatus of claim 1, wherein the elongated member comprises only one distal end.

9) The apparatus of claim 1, the distance between the first image capture device and the connection point is about 50 centimeters.

10) The apparatus of claim 1, further comprising a sleeve structure connected to the pan and tilt rotating mechanism configured to hold the elongated member.

11) The apparatus of claim 10, wherein the sleeve structure is configured to clamp the elongated member at a desired angle relative to a rotating plate while the pan and tilt rotating mechanism rotates the elongated member through various positions.

12) The apparatus of claim 11, wherein the distance of the sleeve structure from the rotating plate can be configured for adjustment so that a user can set the distance between the elongated member and the rotating plate.

13) The apparatus of claim 1, wherein the image capture device comprises a fish eye lens with a direction pointing out from the center of rotation of the pan and tilt rotating mechanism.

14) The apparatus of claim 13, wherein the image capture device is configured to capture image data with the fisheye lens rotated in a spherical path within a static space to capture images and form a three hundred and sixty degree light field view of the static space for utilization in a virtual reality environment.

15) A method, comprising:
attaching a first image capture device having a lens and nodal point to a first distal end of an elongated member attached to a pan and tilt rotating mechanism having a point of rotation and a connection point proximate said rotation point, said connection point at which said elongated member is connected so that the first distal end and the connection point are in spaced relation so as to define a distance between said nodal point and said point of rotation;
causing, by a processor, rotation of the pan and tilt mechanism so that the nodal point traverses a path generally corresponding to a plurality of desired points on a surface of an imaginary sphere having a radius originating at the center of rotation and equal to said distance;
causing, by the processor, rotation of the elongated member during the rotation of the pan and tilt mechanism so that the elongated member completes a single rotation comprising the plurality of desired points for each rotating position of the pan and tilt mechanism; and
capturing, by the first image capture device, images of real world space surrounding the image capture device at each of the desired points.

16) The method of claim 15, further comprising:
attaching a second image capture device to a second distal end of the elongated member.

17) The method of claim 16, wherein the first image capture device and the second image capture device are operated simultaneously.

18) The method of claim 15, further comprising:
capturing, by the second image capture device, images of the real world space at each of the desired points.

19) The method of claim 18, wherein the distance is about 50 centimeters.

20) A method comprising:
attaching an image capture device comprising a lens to a pan and tilt mechanism having a point of rotation and a connection point proximate said rotation point, said connection point at which said image capture device is connected so that a nodal point of the image capture device and the connection point are in spaced relation so as to define a distance between said nodal point and said point of rotation; and
programming the pan and tilt rotating mechanism to traverse a path generally corresponding to a plurality of desired points on a surface of an imaginary sphere having a radius originating at the said point of rotation and terminating at said nodal point; and
programming the image capture device to capture an image of a real world space at each of the plurality of desired points.

21) The method of claim 20, wherein programming the pan and tilt rotating mechanism to traverse a path further comprises:
aiming said image capture device in various directions to intersect the plurality of desired points; and
capturing images at each desired point that is spaced apart from a next desired point by a predetermined degree.

22) The method of claim 20, wherein programming the pan and tilt rotating mechanism to traverse a path is indicated by a plurality of vertical lines and a plurality of horizontal lines, wherein a plurality of intersection points of the vertical and the horizontal lines define the plurality of desired points on the surface of the imaginary sphere.
